(19) United States
(12) Patent Application Publication
(10) Pub. No.: US 2014/0064571 A1
(43) Pub. Date: Mar. 6, 2014

(54) Method for Using Information in Human Shadows and Their Dynamics

(71) Applicant: Adrian Stoica, Pasadena, CA (US)

(72) Inventor: Adrian Stoica, Pasadena, CA (US)

(21) Appl. No.: 13/783,281

(22) Filed: Mar. 2, 2013

Related U.S. Application Data
(62) Division of application No. 12/534,653, filed on Aug. 3, 2009.
(60) Provisional application No. 61/188,097, filed on Aug. 6, 2008.

(51) Int. Cl. G06K 9/62

(52) U.S. Cl. CPC G06K 9/6202
USPC 382/115

(57) ABSTRACT

A method and apparatus to recognize, identify, and authenticate/verify humans and human behavior by using shadow characteristics data, as well as body data in the visible and invisible radiation spectrum.

### CROSS REFERENCE TO RELATED APPLICATIONS

This application is a divisional of U.S. application Ser. No. 12/534,653, filed Aug. 3, 2009, which claims priority to U.S. Ser. No. 61/188,097 filed Aug. 4, 2008, both of which are hereby specifically incorporated by reference herein in their entireties.

### BACKGROUND

1. Field of the Invention

The invention is in the field of biometrics and human identification that relates to using a computerized method of recognizing shadows from airborne platforms for biometric applications.

2. Description of the Background Art

There has been a long history of obtaining intelligence from airborne platforms. Now, satellite imagery has achieved centimeter-level resolution. There are many applications that could benefit from such monitoring power. Such applications derive from remotely obtaining human biometrics and using them for recognition, which then can be used for tracking of wanted terrorists, monitoring drug dealers, or identifying suspect human behavior—as well as animals.

‘Proximity’ biometrics is currently used for the recognition of suspects in controlled environments (e.g. border control), yet, as the distance increases the number of effective analysis techniques drops significantly. While face and iris recognition have been proposed for a long time, both are difficult to implement in wide open spaces and at a remote distance. In addition, these techniques are relatively easily defeated by non-cooperating subjects, for example, wearing head covers and glasses. Gait recognition has a promising potential for remote observation, although the number of applications remains restricted and it can be tempered with; for example, people may distort their gait under the influence of alcohol or wear a small pebble inside the shoes. It may appear that, although these deceptive practices may be adopted by a suspecting individual, it makes no sense to alter the gait without a surveillance threat in the outdoors.

Remote surveillance is made possible by high resolution of space/airborne sensing systems. Although, seen from above, two individuals with similar head covers and similar robes appear alike and largely indistinguishable. A careful analysis of images reveals that while physical bodies in top view are very similar for many individuals, their shadows and the associated dynamics reflecting the gait are not. In addition, shadows are often larger areas offering more specific details, which can be used for biometrics. Thus, shadow biometrics (defined as biometrics using information from shadows) enables a new field of “overhead” biometrics. This includes the remote observation from satellite or airborne platforms and analysis of biometric characteristics, as present in human shadow silhouettes derived from video imagery.

“Shadow biometrics” use shadow information, either without body information, or in combination with it—as an additional perspective, which provides an effect approximately equivalent to the use of a second camera. The “overhead” biometrics process is summarized hereafter. This process segments the shadows from the background imagery. Then the measures of the shadow (shadow metrics) are determined, and use their variation as features, either temporal features or transformed as frequency features, are classified. Classification methods, such as k-nearest neighbor, or other methods are applied to these features. A learning process allows training of the classifiers. Later these are presented with new target features that are later provided with a classification into existing (trained) classes based on the minimization of a distance to these classes.

### SUMMARY OF THE INVENTION

In one embodiment the data from shadows, instead, or in addition to the data obtained from the human bodies that generate the shadows, are used for the purpose of improved classification of individual identities and behaviors of individuals. This data refers to the captured image of the shadow in the visual or invisible domain. While prior methods use information from body motion to determine information about identity and behavior, an example being the analysis of gait, the proposed method is using the information from shadow and shadow motion to determine identity and behavior.

The use of shadows expands the usage of remote imagery to overhead observations, since shadows observed in overhead imagery offer information from a better projection. Additionally, the shadows offer increased differentiation for classification, unlike overhead views of human bodies, which are mostly top view of head and shoulder with limited additional information of other parts of the body and their movement. Such movement may also be partly obstructed to the overhead view.

The information in the shadows is then processed in a sequence that has the following key steps: segmentation of shadows from the rest of the image, in a sequence of frames of the recorded imagery, a compensation and scaling of the shadow to correct for deviations due to the changing position of sun at various moments of time during the day, and due to different directions of walk in relation to the sun, determining a set of shadow metrics and their modification in time, also expressed as a set of coefficients in the frequency domain, and finally performing a classification based on the frequency coefficients and other shadow metrics.

The method and processing sequence may use the information from the shadows. Key steps include: segmentation of the shadows from the rest of the image, in a sequence of frames of the recorded imagery, a compensation and scaling of the shadow to correct for deviations due to the changing position of sun at various moments of time during the day, and due to different directions of walk in relation to the sun, determining a set of shadow metrics and their modification in time, also expressed as a set of coefficients in the frequency domain, and finally performing a classification based on the frequency coefficients and other shadow metrics.

The shadow metrics could also be used in addition to body-determined metrics, such as the gait of the body in direct observation, providing additional information. Several specific shadow metrics (as a function of time) include area of the shadow, the parameters of a triangle model formed by the extremities of head and two feet, the parameters of a pentagonal model former by the extremities of head, two hands and two feet, the parameters of the skeleton model made to fit the shadow at the center of the shape (via skeletonization), etc.

### BRIEF DESCRIPTION OF THE DRAWINGS

FIG. 1. (Top left) shows an image above a city, in the visual domain. A rectangular area from the image is zoomed in, and after rotation and magnification shown in the enlarged window in

FIG. 1. (Top right) shows an image that appears to be the shape of a human body and is in fact the shape of its shadow, a body projection. While the actual body in the top view is hard to distinguish and occupies only a minuscule area at the bottom of the shadow.

FIG. 2. Main steps in processing information in shadows and their dynamics.

FIG. 3. Illustrates the process. The ROI around the moving targets was identified in consecutive frames starting with the one illustrated in FIG. 3 (a); a spatial filter/cropping and a set of intensity/chrominance filters were applied to produce the image illustrated in FIG. 3 (b). One of the moving targets was isolated in FIG. 3(c). This was followed by a separation of the shadow FIG. 3 (d)—with 180 degree rotation; shadow above to illustrate resemblance with human silhouette. The sequence of shadows in consecutive frames, gait is apparent in FIG. 3 (e). From this point, after a compensation for sun position (may be avoided in special cases if one focuses only on relative changes) one determines a set of feature for classification. In FIG. 3(f) a triangle model was fitted to head and feet of the body (shadow) image. A correction for the position of the sun (specific light source) is illustrated in FIG. 3 (g) which gives corrected parameters for the model (here for example angles and one side of a triangle of extremities of head and 2 feet). Correction should normally be applied before determining the features/metrics, but was shown here at this stage for best illustration of the concept. FIG. 3 (h) illustrates the same sequence of model parameters, basis for future analysis of dynamics of features. To this sequence a frequency analysis (some form of Fourier transform) is applied.

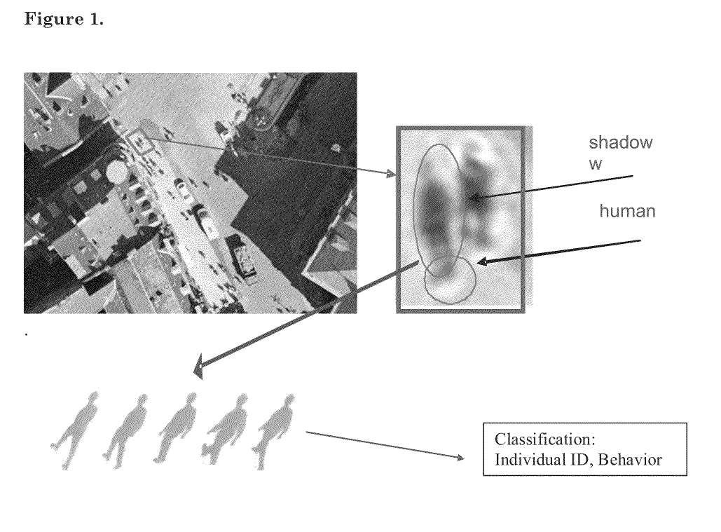

### DETAILED DESCRIPTION OF THE INVENTION

This specification refers to illustration of shadow biometrics process steps. The video/image processing greatly benefits from advances in two main areas: shadow detection/segmentation techniques, which allow extraction of the shadow silhouette, and gait analysis techniques, which extract the information from silhouette movements.

Although there is a large diversity of gait recognition algorithms, a majority have focused on the canonical (side) viewing point using silhouettes for human detection or identification, with several public databases available. For individual identification, correct classification rates based on image processing of gait video reaches 60-80% depending on conditions of observation. Higher values (over 90% for special conditions) are reported for newer gait recognition algorithms. Newer algorithms also effectively compensate for the hard covariates, such as surface, time, carrying condition, and walking speed, by normalizing the gait dynamics based on a population-based generic walking model. Silhouette gait recognition approaches generally fall into two main categories: (1) model-free shape-based analysis, and (2) model-based articulated or structural analysis. Shape-based analysis uses measurements of spatio-temporal features of the silhouette. To characterize shape and its variations different measures may including size (width, height, area), angles between lines (e.g. foot/ankle, upper arm-lower arm), higher order moments around the centroid, measures of symmetry, or other shape representations, and temporal variations such as cyclic oscillations at the stride frequency. Shape-based approaches have been shown very effective for human silhouette detection and have been used with good results on human identification.

Articulated model-based approaches incorporate a human body model composed of rigid body parts interacting at joints. Parameters of the model may include kinematics such as link lengths, widths, and (more rarely used) dynamics such as moments of inertia. The model may be normalized to a standard body dimension or adapted with absolute coordinate measures, depending on application (e.g., for individual identity, absolute measures are good discriminants; for behavioral identity, body normalization is preferred). This approach is best suited for shadow biometrics, because the added complexities of viewing angle, sun angle, and subject heading direction will likely require model-based estimation and tracking as feedback to reliably extract the desired features.

Structural model-based approaches include parameterization of gait dynamics, such as stride length, cadence, and stride speed. Static body parameters, such as the ratio of sizes of various body parts, can be considered in conjunction with these parameters. Traditionally, these approaches have not reported high performances on common databases, partly due to their need for 3D calibration information. However, this approach may prove more efficient for shadow analysis if multiple shadows are used in training.

Each category can be further segregated by inclusion of dynamics: temporal alignment-based vs. static parameter-based. The temporal alignment-based approach emphasizes both shape and dynamics. It treats the sequence as a time series and alignment of sequences of these features, corresponding to the given two sequences to be matched. The alignment process can be based on simple temporal correlation, dynamic time warping, hidden Markov models, phase locked-loops, or Fourier analysis. Static parameter-based approaches emphasize the silhouette shape similarity and downplay temporal information. An image sequence can be transformed, for example using an averaged silhouette or silhouette feature, or treated as just a collection of silhouette shapes while disregarding the sequence ordering. A compromise approach will use stance specific representation, ignoring dynamics between stances, but still preserves the temporal ordering of the individual gait stances.

In one embodiment, the present invention provides computerized method for recognition, identification and authentication/verification of humans and human behavior, by utilizing shadow characteristic data in the visible and in the invisible radiation spectrum. The specialized computing system will collect various sources of data, beginning with data on shadows in the visible and invisible radiation spectrums. It will additionally collect data on the radiation source angle, the observation angle, the subject facing direction, the subject direction of motion, the ground slope at the location of human, the subject position, and the time.

In another embodiment, the specialized computing system will also store the shadow data into a data base on a storage medium of a computer system. The storage medium will store the sun angle into a data base on a storage medium of a computer system, the observation angle into a data base on a storage medium of a computer system, the subject facing direction into a data base on a storage medium of a computer system, the subject direction of motion into a data base on a storage medium of a computer system, the ground slope data into a data base on a storage medium of a computer system, the data on subject position, and the data on time.

In another embodiment, the specialized computing system will also isolate an individual shadow from the entire stored image.

In a preferred embodiment, the specialized computing system will also perform computerized method of shadow dynamics analysis. The analysis will sample the shadow data at predetermined periods of time, normalize each of the sampled shadow data set, create a sequence out of the normalized shadow data sets, store the sequence of normalized shadow data sets, and calculate a Key Node Value (KNV) feature vector for each normalized shadow data set.

In another embodiment, the shadow dynamics analysis will also match the calculated KNV feature vector with the reference KNV stored in the reference data base.

In another embodiment, the shadow dynamics analysis will match the smallest differential between the calculated KNV and the stored KNV.

In a preferred embodiment, the specialized computing system will also perform a method of group dynamics analysis. The group dynamic analysis will capture an image with multiple individual shadows, separate each individual shadow in the image, normal each individual shadow, calculate the KNV for each individual shadow, and aggregate the individual KNV into one Collective KNV (CKNV).

In another embodiment, the group dynamics analysis will also match the calculated CKNV with the reference CKNV stored in the reference data base. The group dynamics analysis may also look for the smallest differential between the calculated CKNV and the stored CKNV.

In a preferred embodiment, the specialized computing system will also recognize and identify humans and human behavior, by combining shadow characteristic data in the visible and in the invisible radiation spectrum with body characteristic data. The computing system will recognize and identify humans and human behavior by calculating the KNV for each normalized shadow data set. It may also match the calculated Com-KNV with the reference Com-KNV stored in the reference data base. Lastly, it may match by looking for the smallest differential between the calculated Com-KNV and the stored Com-KNV.

In another preferred embodiment, the present invention provides an apparatus used as a means for recognition, identification and authentication/verification of humans and human behavior, by utilizing shadow characteristic data in the visible and in the invisible radiation spectrum. The apparatus contains the means for collecting data on shadows in the visible and invisible radiation spectrums, the radiation source angle, the observation angle, the subject facing direction, the subject direction of motion, ground slope at the location of human, subject position, and collecting data on the time.

In another embodiment, the apparatus may also provide the means for, storing the shadow data into a data base on a storage medium of a computer system. The apparatus may also store the sun angle into a data base on a storage medium of a computer system. The storage medium may also store the observation angle, the subject facing direction, the subject direction of motion, the ground slope data, the data on subject position, and the data on the time.

In another embodiment, the apparatus may also provide the means for, isolating an individual shadow from the entire stored image.

In another embodiment, the apparatus will also analyze shadow dynamics by sampling the shadow data at predetermined periods of time, normalizing each of the sampled shadow data set, creating a sequence out of the normalized shadow data sets, storing the sequence of normalized shadow data sets, and calculating a Key Node Value (KNV) feature vector for each normalized shadow data set.

In another embodiment, the apparatus will also analyze shadow dynamics by matching the calculated KNV feature vector with the reference KNV stored in the reference data base and also by matching the smallest differential between the calculated KNV and the stored KNV.

In another embodiment, the apparatus will perform a computerized method of group dynamics analysis. The analysis will be accomplished by capturing an image with multiple individual shadows, separating each individual shadow in the image, normalizing each individual shadow, calculating the KNV for each individual shadow, and aggregating the individual KNV into one Collective KNV (CKNV).

In another embodiment, the apparatus will perform a computerized method of group dynamics analysis by matching the calculated CKNV with the reference CKNV stored in the reference data base. The matching may also of looking for the smallest differential between the calculated CKNV and the stored CKNV.

In another embodiment, the apparatus will recognize and identify humans and human behavior, by combining shadow characteristic data in the visible and in the invisible radiation spectrum with body characteristic data. This will be accomplished by calculating the KNV for each normalized shadow data set. This may also be accomplished by matching the calculated Com-KNV with the reference Com-KNV stored in the reference data base. The apparatus will further recognize and identify humans and human behavior, by looking for the smallest differential between the calculated Com-KNV and the stored Com-KNV.

In a preferred embodiment, the present invention provides a computer executable software module that gives an apparatus the capability to perform recognition, identification and authentication/verification of humans and human behavior, by utilizing shadow characteristic data in the visible and in the invisible radiation spectrum. The specialized computing system will be executed by collecting data on shadows in the visible and invisible radiation spectrums, the radiation source angle, the observation angle, the subject facing direction, the subject direction of motion, ground slope at the location of human, subject position, and collect data on the time.

In another embodiment, the computer executable software will further have the capability of storing the shadow data into a data base on a storage medium of a computer system. The computer executable software will store the sun angle, the observation angle, the subject facing direction, the subject direction of motion, the ground slope data, the data on subject position, and will store the data on the time.

In another embodiment, the computer executable software will further have the capability of isolating an individual shadow from the entire stored image.

In another embodiment, the computer executable software will give an apparatus the capability of sampling the shadow data at predetermined periods of time, normalizing each of the sampled shadow data set, creating a sequence out of the normalized shadow data sets, storing the sequence of normalized shadow data sets, and calculating a Key Node Value (KNV) feature vector for each normalized shadow data set.

In another embodiment, the computer executable software will give an apparatus the capability of matching the calculated KNV feature vector with the reference KNV stored in the reference data base.

In another embodiment, the computer executable software will further give an apparatus the capability of matching the smallest differential between the calculated KNV and the stored KNV.

In another embodiment, the computer executable software module gives an apparatus the capability of performing computerized method of group dynamics analysis. The analysis will include capturing an image with multiple individual shadows, separating each individual shadow in the image, normalizing each individual shadow, calculating the KNV for each individual shadow, and aggregating the individual KNV into one Collective KNV (CKNV).

In another embodiment, the computer executable software module further gives an apparatus the capability of matching the calculated CKNV with the reference CKNV stored in the reference data base.

In another embodiment, the computer executable software module gives an apparatus the capability of matching that consists of looking for the smallest differential between the calculated CKNV and the stored CKNV.

In another embodiment, the computer executable software module gives an apparatus the capability for recognition and identification of humans and human behavior, by combining shadow characteristic data in the visible and in the invisible radiation spectrum with body characteristic data. The apparatus calculates the KNV for each normalized shadow data set.

In another embodiment, the computer executable software module gives an apparatus the capability of matching the calculated Com-KNV with the reference Com-KNV stored in the reference data base.

In another embodiment, the computer executable software module gives an apparatus the capability of matching consists of looking for the smallest differential between the calculated Com-KNV and the stored Com-KNV.

### Example

### The Methodology

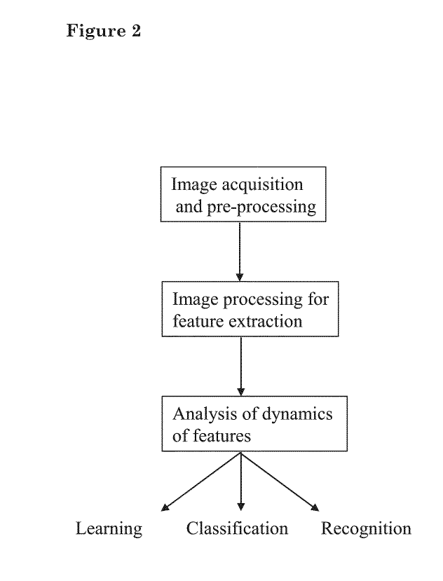

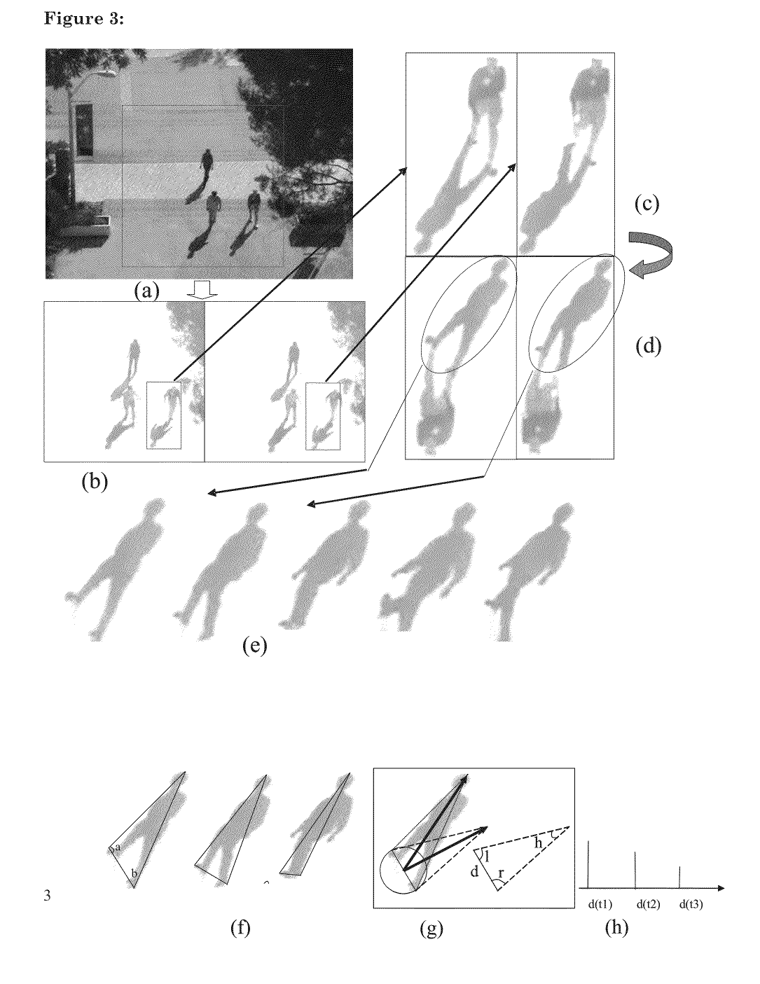

The high-level steps of extracting information from multi-frame imagery with shadows are summarized in a diagram in FIG. 2 and illustrated with an example in FIG. 3. The steps are detailed in the following:

### Step 1.

In a first step, one performs multi-frame image acquisition and pre-processing with the purpose of shadow segmentation (extraction, or separation from the rest of the image) and the creation of a temporal sequence of shadows. The extraction/segmentation of shadows can be done by a background substraction, e.g. removing a common or initial frame of reference, possibly by performing first a detection of regions of change between frames, which isolates humans and other objects that move (e.g. subtraction of consecutive frames) and then further isolates and tracks the shadows, or through discrimination/segmentation of shadows by the application of various color filters to isolate and extract the shadows from the rest of the object in the image. Finally, a scaling/compensation is performed for the (known) position of the sun/observing platform (which also allows for the computation of the actual height of the person) and other variables, such as direction of walk compared to the sun direction.

Image acquisition and pre-preprocessing may involve the following sub-steps, which can be, but not necessarily, performed in the order indicated here.

Identification of regions of interest (ROI), which display the change over consecutive frames; focus of attention/isolation of ROI-tracking over multiple frames (spatial-temporal filters)
Application of intensity/chrominance filters.

In certain cases it may be advantageous to apply color filters and segment the shadows directly, without seeking for ROI and without isolation of the pair body-shadow.

A segmentation—isolation of people and their shadows by background substraction or directly segmentation of shadows only
A separation/segmentation of the shadows if body-shadow pairs were isolated together
Compensations (transformation, scaling) to a “normalized” silhouette:

To compensate for different shadow angles/sizes based on the information of the light source (e.g. variability due to variation in sun direction), position of person and observation camera, from a known time of the day, inclination of the sun rays from time/position of the sun for given longitude/latitude, position of the platform one applies a transform. In certain cases it is advantageous to scale the shadow silhouette to a uniform height and aligned with respect to its horizontal centroid. Nevertheless the information used in scaling is still useful, since it contains individual characteristic information (such as the individual's height) which is useful to individual classification/recognition (although may not be useful for behavior classification).

### Step 2.

In a second step one performs feature extraction, and shadows suffer further image and data processing to extract parametric features such as geometrical characteristics of the shadows, to be used in the next step for classification/recognition. These features may include measures of the area covered by the shadow (in shape, matching a triangle and a pentagon—for head/feet or head/feet/hands extremities), etc.

Processing for feature extraction may involve one or more of the operations below:

### Shadow Area Calculation

Extracting parameters for a triangular model (triangle of extremities of head and 2 feet)
Extracting parameters for a pentagonal model (triangle of extremities of head, two hands and 2 feet)
Skeletonization, and computing of dimensions of segments in the skeleton Extracting parameters of a 3D model

### Step 3.

A third and final step consists of an analysis of the dynamics of the features, for learning and then recognition/classification.

Since the gait motion is repetitive in time, the characteristic feature is also repetitive and a gait cycle is determined.

Analysis of dynamics of features may include:
Amplitude and periodicity of variation of a certain feature
Deviation from Regularity
Frequency analysis—determination of the spectral coefficients and various functions of the coefficients (such as, for example, their ratios).

The process described above was tested with images recorded from a camera above a building.

Only the shadows were processed, although in this case the human bodies were also visible with reasonable detail, and the combined info of body-shadow pair would have been provided enhanced discrimination capability in this case, compared to body only but also to shadow-only.

1. A computerized method of shadow dynamics analysis, the method comprising:
sampling the shadow data at predetermined periods of time,
normalizing each of the sampled shadow data set,
creating a sequence out of the normalized shadow data sets,
storing the sequence of normalized shadow data sets, and
calculating a Key Node Value (KNV) feature vector for each normalized shadow data set.

2. The computerized method of claim 1, further comprising
matching the calculated KNV feature vector with the reference KNV stored in the reference data base.

3. The computerized method of claim 2, wherein the matching consists of looking for the smallest differential between the calculated KNV and the stored KNV.

4. A computerized method of group dynamics analysis, the method comprising:
capturing an image with multiple individual shadows,
separating each individual shadow in the image,
normalizing each individual shadow,
calculating the KNV for each individual shadow, and
aggregating the individual KNV into one Collective KNV (CKNV).

5. The computerized method of claim 4, further comprising
matching the calculated CKNV with the reference CKNV stored in the reference data base.

6. The computerized method of claim 5, wherein the matching consists of looking for the smallest differential between the calculated CKNV and the stored CKNV.

7. An apparatus for shadow dynamics analysis, comprising of means of
sampling the shadow data at predetermined periods of time,
normalizing each of the sampled shadow data set,
creating a sequence out of the normalized shadow data sets,
storing the sequence of normalized shadow data sets, and
calculating a Key Node Value (KNV) feature vector for each normalized shadow data set.

8. The apparatus of claim 7, further comprising means of
matching the calculated KNV feature vector with the reference KNV stored in the reference data base.

9. The apparatus of claim 8, wherein the matching consists of looking for the smallest differential between the calculated KNV and the stored KNV.

10. An apparatus for performing computerized method of group dynamics analysis, the apparatus comprising of means of:
capturing an image with multiple individual shadows,
separating each individual shadow in the image,
normalizing each individual shadow,
calculating the KNV for each individual shadow, and
aggregating the individual KNV into one Collective KNV (CKNV).

11. The apparatus of claim 10, further comprising of means for matching the calculated CKNV with the reference CKNV stored in the reference data base.

12. The apparatus of claim 11, wherein the matching consists of looking for the smallest differential between the calculated CKNV and the stored CKNV.

13. A computer executable software module giving an apparatus the capability of sampling the shadow data at predetermined periods of time, normalizing each of the sampled shadow data set, creating a sequence out of the normalized shadow data sets, storing the sequence of normalized shadow data sets, and calculating a Key Node Value (KNV) feature vector for each normalized shadow data set.

14. The computer executable software module of claim 13, further giving an apparatus the capability of matching the calculated KNV feature vector with the reference KNV stored in the reference data base.

15. The computer executable software module of claim 14, further giving an apparatus the capability of matching that consists of looking for the smallest differential between the calculated KNV and the stored KNV.

16. A computer executable software module of that gives an apparatus the capability of performing computerized method of group dynamics analysis, the apparatus comprising of means of:
capturing an image with multiple individual shadows,
separating each individual shadow in the image,
normalizing each individual shadow,
calculating the KNV for each individual shadow, and
aggregating the individual KNV into one Collective KNV (CKNV).

17. The computer executable software module of claim 16, that further gives an apparatus the capability of matching the calculated CKNV with the reference CKNV stored in the reference data base.

18. The computer executable software module of claim 17, that further gives an apparatus the capability of matching consists of looking for the smallest differential between the calculated CKNV and the stored CKNV.
